(19) United States
(12) Patent Application Publication
(10) Pub. No.: US 2008/0218659 A1
(43) Pub. Date: Sep. 11, 2008

(54) WHITE SURFACE LIGHT SOURCE AND LIQUID CRYSTAL DISPLAY

(75) Inventors: Hiroko KANAYA, Niihama-shi (JP); Akiyoshi Kanemitsu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED, Tokyo (JP)

(21) Appl. No.: 12/042,394

(22) Filed: Mar. 5, 2008

(30) Foreign Application Priority Data
Mar. 7, 2007 (JP) 2007-057186

(51) Int. Cl. G02F 1/13357; F21V 1/00

(52) U.S. Cl. 349/64; 362/311

(57) ABSTRACT

A white surface light source comprising a light diffuser plate and a light source provided on the back side of the light diffuser plate, wherein the light source comprises at lease one LED element which emits lights including a red color, and the light diffuser plate comprises a transparent material and light diffusing particles dispersed in the transparent material, and wherein an absolute value An of a refractive index difference between the transparent material and the light diffusing particles, and a 50% cumulative particle diameter D₅₀ (μm) of the light diffusing particles satisfy the relationship: 0.25<Δn×D₅₀<0.61 or 0.75<Δn'D₅₀.

### FIELD OF THE INVENTION

The present invention relates to a surface, light source having high whiteness which comprises light emitting diodes (LEDs) as light sources, and a liquid crystal display capable of achieving natural color display using such a surface light source.

### DESCRIPTION OF THE RELATED ART

It is proposed to use LEDs as light sources of a backlight for a liquid crystal display, in place of a conventional cold cathode fluorescent tube (see, for example, “LED Backlight Changing TV Colors”, NIKKEI ELECTRONICS, Nikkei BP Marketing, Inc., published on—Dec. 20, 2004, Issue 2004-12-20, No. 889, pp. 57-62; and “Backlight Technique for Liquid Crystal Display—TLquad Crystal Illumination System and Materials—”, CMC Publishing Co., Ltd., published on Aug. 31, 2006, pp. 148-149). Namely, it is proposed to use red, green and blue LEDs as light sources of the backlight for the liquid crystal display. Intense interest has recently been shown towards a liquid crystal display using LEDs of three colors, R (red), G (green) and B (blue), since such a liquid crystal display has advantages such that the range of a color reproducibility can be incresed, that the liquid crystal display is free from mercury and is thus friendly to the global environment, and that it has a long lifetime.

When the backlight system comprises red, green and blue LEDs described above, that is, three kinds of LEDs capable of emitting lights of red, green and blue color each having a different wavelength, the ratio of the light amounts of three kinds of red, green and blue LEDs should be adjusted to obtain white light over the entire surface of the backlight.

However, when lights emitted from three kinds of red, green and blue LEDs (red light, green light and blue light) pass through a light diffuser plate, diffused light to be emitted from the surface of the backlight tends to become reddish white light, since light diffusing properties depend on wavelengths. Therefore, a liquid crystal display such as a liquid crystal TV screen comprising such a LED backlight suffers from a problem that high-quality images cannot be achieved because the displayed color images are slightly reddish.

Compounding some dyes that absorb red light into the light diffuser plate may be conceived to solve the problem of a red tinge. In such a case, there arises another problem such that the total amount of the light emitted from the surface light source is decreased because of the absorption of red light and thus sufficient luminance cannot be obtained.

### SUMMARY OF THE INVENTION

An object of the present invention is to provide a surface light source capable of emitting diffused light having high whiteness with substantially no red tinge.

Another object of the present invention is to provide a liquid crystal display capable of displaying natural and high-quality color images with substantially no red tinge.

According to the first aspect, the present invention provides a white surface light source comprising a light is diffuser plate and a light source provided on the back side of the light diffuser plate,
wherein the light source comprises at least one LED element which emits lights including a red color, and the light diffuser plate comprises a transparent material and light diffusing particles dispersed in the transparent material, and
wherein an absolute value Δn of a refractive index difference between the transparent material and the light diffusing particles, and a 50% cumulative particle diameter D₅₀ (μm) of the light diffusing particles satisfy the relationship:

0.25<Δn×D₅₀<0.61 or

0.75<Δn×D₅₀.

According to the second aspect, the present invention provides a liquid crystal display comprising the above white surface light source according to the present invention, and a liquid crystal panel provided on a front side (a light-emitting side) of the white surface light source unit.

As the LED elements, for example, light source elements including red, green and blue LEDs are used.

With the white surface light source according to the first aspect of the present invention, among lights which pass through the light diffuser plate, light in a long wavelength range (i.e. red light) is more strongly diffused, since the light diffuser plate satisfies the relationship: 0.25<Δn×D₅₀<0.61 or 0.75<Δn×D₅₀. As a result, the red tinge of the diffused light emitted from the light emitting face of the surface light source unit is remarkably decreased and thus diffused light having high whiteness with substantially no red tinge can be emitted.

With the liquid crystal display according to the second aspect of the present invention, the color of the liquid crystal panel can be accurately reproduced, since diffused light having high whiteness with substantially no red tinge can be emitted from the surface light source, although LEDs are used as the light source elements.

### BRIEF DESCRIPTION OF THE DRAWINGS

FIG. 1 is a schematic side view showing one embodiment of a liquid crystal display according to the present invention.

FIG. 2 is a plan view showing one embodiment of an arrangement pattern of LED elements (LED chips).

FIG. 3 is a schematic side view showing the modification of an arrangement pattern of LED elements in a surface light source.

### DETAILED DESCRIPTION OF THE INVENTION

FIG. 1 shows one embodiment of a liquid crystal display (1) according to the present invention. The liquid crystal display (1) comprises a surface emission light source (9) and a liquid crystal panel (30) provided on the front side of the surface emission light source (9).

The liquid crystal panel (30) comprises a liquid crystal cell (20) constituted by interposing a liquid crystal (11) between a pair of transparent electrodes (12) and (13) disposed in parallel at a distance from each other, and polarizer plates (14) and (15) placed on both sides of the liquid crystal cell (20). These components (11), (12), (13), (14) and (15) constitute a displaying module. An retardation film (not shown) is laminated on the inner surface (facing the liquid crystal) of each of the transparent electrodes (12) and (13).

The surface light source unit (1) is provided on the lower surface side (back surface side) of the bottom side polarizer plate (15). The surface light source (9) comprises a lamp box (5) of a thin box structure having a rectangular shape in plan view which is open on the top surface side (front surface side), a plurality of LED elements (2) arranged at a distance from each other in the lamp box (5), and a light diffuser plate (3) provided on the upper side (front surface side) of the plurality of LED elements (2). The light diffuser plate (3) is fixed to the lamp box (5) so as to cover the opening on the front side of the lamp box. On the inside surface of the lamp box (5), a light reflection layer (not shown) is formed.

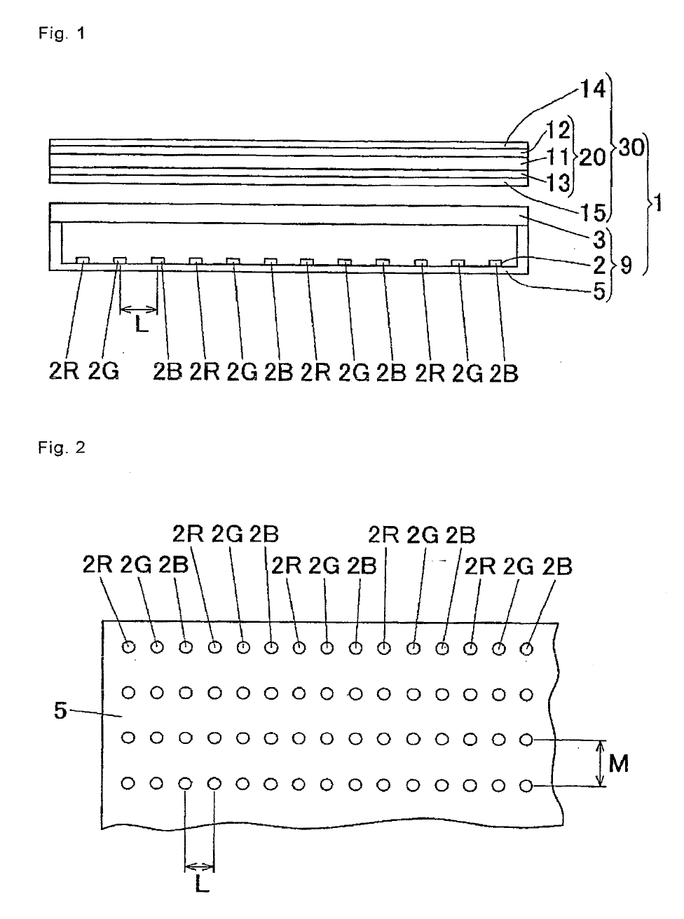

The LED elements (2) may have any construction as long as they include LED elements which emit lights including a red color (LED elements which emit lights including a red color as a dominant wavelength). In this embodiment, a plurality of red LEDs (2R), a plurality of green LEDs (2G) and a plurality of blue LEDs (2B) are used as the LED elements (2) (see FIGS. 1 and 2). Examples of the arrangement mode of these red LEDs (2R), green LEDs (2G) and blue LEDs (2B) include, but are not limited to, a substantially grid-shaped arrangement (a substantially lattice-shaped arrangement) as shown in FIG. 2, a regular arrangement such as a zigzag arrangement, and an irregular arrangement arranged at random. The red LED, green LED and blue LED may be an individual package type one in which these LEDs are separated from each other as shown in the embodiment shown in FIGS. 1 and 2, or an RGB one-package type one in which a red light emission portion, a green light emission portion and a blue light emission portion are incorporated into one LED package (see Table 4 on page 149 of “Backlight Technique for Liquid crystal Display—Liquid Crystal Illumination System and Materials—” supra)

The light diffuser plate (3) is a plate formed from a transparent material containing light diffusing particles dispersed therein.

The light diffuser plate (3) is formed so that the absolute value Δn of the refractive index difference between the transparent material and the light diffusing particles, and the 50% cumulative particle diameter Dso (μm) of the light diffusing particles satisfy the relationship: 0.25<Δn×D₅₀<0.61 or 0.75<Δn×D₅₀. The transparent material and the light diffusing particles satisfying one of the above relationships are used to form the light diffuser plate (3).

In the surface light source unit (9) having the structure described above, among lights passing through the light diffuser plate, light in a long wavelength range (red light) is diffused more strongly than other lights since the light diffuser plate satisfies the relationship: 0.25<Δn×D₅₀<0.61 or 0.75<Δn×D₅₀. As a result, the red tinge of the diffused light emitted from the light emitting side of the surface light source unit is remarkably decreased and thus diffused light having high whiteness with substantially no red tinge can be emitted.

Therefore, the liquid crystal display (1) can accurately reproduce the color of the liquid crystal panel, since diffused light having high whiteness with substantially no red tinge is emitted from the surface light source (9) toward the liquid crystal panel (30). Accordingly, natural and high-quality color images having high whiteness with substantially no red tinge can be achieved.

Among the arrangements of matrix material and light diffusing particles satisfying the relationship: 0.75<Δn×D₅₀, a structure satisfying the relationship; 0.75<Δn×D₅₀<1.10 is particularly preferable since the surface light source unit (9) can emit light having high whiteness.

If the relationship; Δn×D₅₀<0.25 or the relationship: 0.61<Δn×D₅₀<0.75 is met, the degree of diffusion of light in a long wavelength range (i.e. red light) is insufficient, or light in a short wavelength range (for example, blue light) is more strongly diffused, and thus the surface light source (9) emits light having larger red tinge and cannot emit light having high whiteness. As a result, a liquid crystal display capable of displaying natural and high-quality color images cannot be obtained.

The type of the light diffuser plate (3) is not specifically limited as long as it is a plate formed from a transparent material containing light diffusing particles dispersed therein, and any light diffuser plate can be used.

Examples of the transparent material include, but are not limited to, glass and transparent resins. Specific examples of the transparent material include a polycarbonate resin, an ABS resin (an acrylonitrile-styrene-butadiene copolymer resin), a methacrylic resin, a MS resin (a methyl methacrylate-styrene copolymer resin), a polystyrene resin, an AS resin (an acrylonitrile-styrene copolymer resin), and a polyolefin resin (for example, polyethylene or polypropylene).

The kind of light diffusing particles (light diffuser) is not specifically limited as long as they are particles having a refractive index different from that of the transparent material which constitutes the light diffuser plate (3) and can diffuse transmitted light, and any light diffusing particles may be used. Specific examples thereof include inorganic particles such as glass particles, silica particles, aluminum hydroxide particles, calcium carbonate particles, barium sulfate particles, titanium oxide particles, and talc; and resin particles such as styrenic polymer particles, acrylic polymer particles, and polysiloxane particles.

The amount of the light diffusing particles to be added is preferably adjusted in a range from 0.01 to 20 parts by weight per 100 parts by weight of the transparent material. When the amount is 0.01 part by Freight or more, a sufficient light diffusing function is attained, while when the amount is 20 parts by weight or less, the lowering of the degree of diffusion in the long wavelength range (i.e. red light) is prevented.

The 50% cumulative particle diameter (D₅₀) of the light diffusing particles is usually 20 μm or less, preferably from 0.3 to 15 μm.

The absolute value Δn of the refractive index difference between the transparent material and the light diffusing particles is usually adjusted in a range from 0.01 to 0.20, and preferably from 0.02 to 0.18.

The light diffuser plate (3) may contain any conventional additive such as ultraviolet absorbers, heat stabilizers, antioxidants, weather resistance agents, photostabilizers, fluorescent whitening agents, processing stabilizers, etc. It is also possible to add light diffusing particles other than the light diffusing particles which satisfy the above specific relationship as long as the effects of the present invention are not adversely affected.

The thickness of the light diffuser plate (3) is not specifically limited. It is usually from 0.05 to 15 mm, preferably from 0.1 to 10 mm, more preferably from 0.5 to 5 mm.

A coating layer may optionally be applied on the surface of the light diffuser plate (3) as long as the effects of the present invention are not adversely affected. When the coating layer is applied, the thickness thereof is preferably adjusted to 20% or less, particularly preferably 10% or less, of the thickness of the light diffuser plate (3).

As a method for producing the light diffuser plate (3), a molding method known as a method for molding a resin plate may be used, and examples thereof include, but are not limited to, a heat press molding method, a melt extrusion method and an injection molding method.

In the present invention, the number of LEDs of the respective colors constituting the LED light source (2) may be selected so that the ratio of LEDs is appropriately adjusted to obtain light having high whiteness over the entire area of the surface light source unit (9). The order of arrangement of LEDs of the respective colors is not specifically limited, and may be the order of arrangement so as to obtain light having high whiteness over the entire area of the surface light source (9). The total number of LEDs may be appropriately selected according to the required luminance.

The distance (L) between adjacent LED elements (2) in a transverse direction (lengthwise direction of an image plane) is usually adjusted in a range from 5 to 50 mm, while the distance (M) between adjacent LED elements (2) in a longitudinal direction (height direction of an image plane) is usually adjusted in a range from 20 to 100 nm (see FIG. 2).

In the above embodiment, the structure comprising red, green and blue LEDs is employed as the LED elements (2), but is not limited to such a combination. It is also possible to employ a combination in which at least one LED capable of emitting light of other color is used, in addition to these red, green and blue LEDs so as to further improve color reproducibility.

The configuration of the LED elements (2) is not limited to one including at least red, green and blue LEDs, and may be any configuration as long as it comprises a LED element capable of emitting lights including a red color. For example, a configuration with red LEDs, LEDs capable emitting light of a color different from a red color, and LEDs capable of emitting light of a color different from the colors of these two LEDs may be employed.

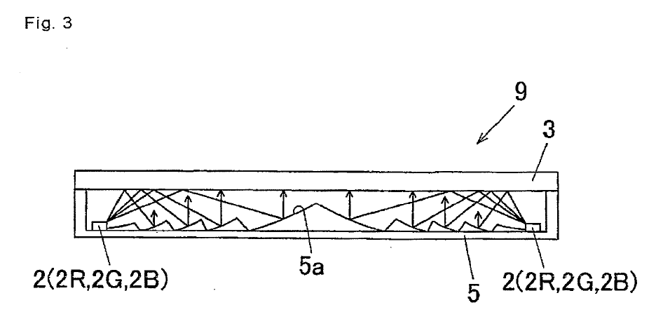

In the above embodiment, the LED light source (2) is arranged in a substantially dispersed state from the center region to the peripheral region in the back side of the light diffuser plate (3) (see FIGS. 1 and 2). However, the configuration is not limited to such a configuration. For example, as shown in FIG. 3, it is also possible to employ a configuration in which the LED elements (2) are arranged only in a pair of the peripheral regions in the back side of the light diffuser plate (3). In FIG. 3, the reference numeral (5a) denotes a light reflector.

The surface light source (9) and the liquid crystal display (1) according to the present invention are not limited to those of the embodiments described above, and any design modifications within the scope of the claims may be made without deviating from the spirit of the invention.

### EXAMPLES

The present invention will be illustrated by the following Examples, which do not limit the scope of the present invention in any way.

### Example 1

One hundred (100) parts by weight of a polystyrene resin and 0.3 part by weight of silicone resin particles (“Tospearl 120” manufactured by Momentive Performance Materials Inc. (formerly Toshiba Silicone Co., Ltd.)) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the silicone resin particles was 1.43. Thus, the absolute value (Δn) of the refractive index difference was 0.16. The 50% cumulative particle diameter (D₅₀) of the silicone resin particles was 1.7 (μm)

Using this light diffuser plate (3), a liquid crystal display (1) having the configuration shown in FIG. 1 was assembled. As a light source (2), an LED light source, unit comprising red LEDs, green LEDs and blue LEDs (LED light source removed from a commercially available 40-inch liquid crystal TV set, product number: XDM-4000 Q, manufactured by SONY Inc.) was used.

### Example 2

One hundred (100) parts by weight of a polystyrene resin and 1.2 parts by weight of an acrylic resin particles (“Techpolymer MBX-5” manufactured by Sekisui Chemical Co., Ltd.) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the acryl resin particles was 1.49. Thus, the absolute value (Δn) of the refractive index difference was 0.10. The 50% cumulative particle diameter (D₅₀) of the acrylic resin particles was 4.2 (μm). Then, a liquid crystal display with the structure shown in FIG. 1 was assembled using the light diffuser plate (3). As a light source (2), the same LED light source as one used in Example 1 was used.

### Example 3

One hundred (100) parts by weight of a polystyrene resin and 2.0 parts by weight of acrylic resin particles (“Techpolymer MBX-8” manufactured by Sekisui Chemical Co., Ltd.) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the acrylic resin particles was 1.49. Thus, the absolute value (Δn) of the refractive index difference was 0.10. The 50% cumulative particle diameter (D₅₀) of the acryl resin particles was 6.0 (μm). Then, a liquid crystal display with the configuration shown in FIG. 1 was assembled using the light diffuser plate (3). As a light source (2), the same LED light source as one used in Example 1 was used.

### Example 4

One hundred (100) parts by weight of a polystyrene resin and 0.8 parts by weight of silicone resin particles (“Tospearl 3120”, manufactured by Momentive Performance Materials Inc.) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the silicone resin particles was 1.43. Thus, the absolute value (Δn) of the refractive index difference was 0.16. The 50% cumulative particle diameter (D₅₀) of the silicone resin particles was 6.4 (μm). Then, a liquid crystal display with the configuration shown in FIG. 1 was assembled using the light diffuser plate (3). As a light source (2), the same LED light source as one used in Example 1 was used.

### Comparative Example 1

One hundred (100) parts by weight of a polystyrene resin and 0.1 parts by weight of silicone resin particles (“XC99-A8808”, manufactured by Shin-Etsu Chemical Co., Ltd.) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the silicone resin particles was 1.43. Thus, the absolute value (Δn) of the refractive index difference was 0.16. The 50% cumulative particle diameter (D₅₀) of the silicone resin particles was 0.6 (μm). Then, a liquid crystal display with the configuration shown in FIG. 1 was assembled using the light diffuser plate (3). As a light source (2), the same LED light source as one used in Example 1 was used.

### Comparative Example 2

One hundred (100) parts by weight of a polystyrene resin and 1.0 parts by weight of an acrylic resin particles (“Techpolymer MBX-2H” manufactured by Sekisui Chemical Co., Ltd.) (light diffusing particles) were mixed in a Henschel mixer, and then the mixture was melt-kneaded and extruded with an extruder to produce a light diffuser plate (3) having a-thickness of 2 mm. The refractive index of the polystyrene resin was 1.59 and that of the acrylic resin particles was 1.49. Thus, the absolute value (Δn) of the refractive index difference was 0.10. The 50% cumulati-v particle diameter (D₅₀) of the acrylic resin particles was 2.3 (μm). Then, a liquid crystal display with the structure shown in FIG. 1 was assembled using the light diffuser plate (3). As a light source (2), the same LED light source as one used in Example 1 was used.

### Comparative Example 3

One hundred (100) parts by weight of a polystyrene resin and 0.5 parts by weight of silicone resin particles (“Tospearl 145”, manufactured by Momentive Performance Materials Inc.) (light diffusing particles) were mixed in a Henschel mixer, and then the mixture was melt-kneaded and extruded with an extruder to produce a light diffuser plate (3) having a thickness of 2 mm. The refractive index of the polystyrene resin was 1.59 and that of the silicone resin particles was 1.43. Thus, the absolute value (Δn) of the refractive index difference was 0.16. The 50% cumulative particle diameter (D₅₀) of the silicone resin particles was 3.9 (μm). Then, a liquid crystal display with the configuration shown in FIG. 1 was assembled using the light diffuser plate (3). As a light source (2), the same LED light source as one used in Example 1 was used.

### Reference Example 1

A liquid crystal display (1) was assembled in the same manner as in Comparative Example 1 except that a fluorescent light tubes were used in place of the LED elements as the light source (2).

### Reference Example 2

A liquid crystal display (1) was assembled in the same manner as in Comparative Example 2 except that a fluorescent light tubes were used in place of the LED elements as the light source (2).

### Reference Example 3

A liquid crystal display (1) was assembled in the same manner as in Example 1 except that a fluorescent light tubes were used in place of the LED elements as the light source (2).

### Reference Example 4

A liquid crystal display (1) was assembled in the same manner as in Example 2 except that a fluorescent light tubes were used in place of the LED elements as the light source (2).

### Reference Example 5

A liquid crystal display (1) was assembled in the same manner as in Example 3 except that a fluorescent light tubes were used in place of the LED elements as the light source (2).

### Reference Example 6

A liquid crystal display (1) was assembled in the same manner as i Comparative Example 3 except that a fluorescent light tubes were used in place of the LED elements as the light source (2).

### Reference Example 7

A liquid crystal display (1) was assembled in the same manner as in Example 4 except that a fluorescent light tubes were used in place of the LED elements as the light source (2).

### Measurement of 50% Cumulative Particle Diameter of Light Diffusing Particles

A 50% cumulative particle diameter (D₅₀) was measured by a Fraunhofer diffraction method by using a microtrac particle diameter analyzer (Model 9220FRA) manufactured by NIKKISO Co., Ltd. in which forward light scattering of laser light is used. Upon measurement, light diffusing particles (about 0.1 g) were dispersed in methanol to obtain a dispersion liquid. The dispersion liquid was irradiated with ultrasound for 5 minutes and the dispersion liquid was poured into a sample vessel of a microtrac particle diameter analyzer, followed by measurement. The 50% cumulative particle diameter (D₅₀) means a particle diameter of particles determined as follows:

The particle diameters and the volumes of all particles are measured and the volumes are cumulatively added from particles having the smallest particle diameter to those having larger particle diameters, and then the particle diameter of particles in which the cumulative volume accounts for 50% of the total volume of all particles is determined.

Each of the liquid display devices thus assembled was evaluated according to the following evaluation method.

Evaluation of Color Quality of Image

With each of the liquid crystal displays, an image on a liquid crystal display was visually observed from the normal direction in a state of being illuminated by an LED light source, and then color quality of the visually observed image was evaluated. Liquid crystal displays with which a natural color image with no red tinge is displayed were rated “A” (Good), those with slight red tinge were rated “B” (Fair), and those with drastic red tinge were rated “C” (Poor).

The results are shown in Table 1 and Table 2.

TABLE 1

| | Structure of light diffuser plate | | | | | Evaluation of |
|---|---|---|---|---|---|---|
| Example | Refractive | Refractive index of | | D₅₀ | | color quality |
| No | index of resin | light diffusing particles | Δn | (μm) | Δn × D₅₀ | of image |
| C. Ex. 1 | 1.59 | 1.43 | 0.16 | 0.6 | 0.10 | C |
| C. Ex. 2 | 1.59 | 1.49 | 0.10 | 2.3 | 0.23 | B |
| Ex. 1 | 1.59 | 1.43 | 0.16 | 1.7 | 0.27 | A |
| Ex. 2 | 1.59 | 1.49 | 0.10 | 4.2 | 0.42 | A |
| Ex. 3 | 1.59 | 1.49 | 0.10 | 6.0 | 0.60 | A |
| C. Ex. 3 | 1.59 | 1.43 | 0.16 | 3.9 | 0.62 | C |
| Ex. 4 | 1.59 | 1.43 | 0.16 | 6.4 | 1.02 | A |

TABLE 2

| | Constitution of light diffuser plate | | | | | Evaluation of |
|---|---|---|---|---|---|---|
| | Refractive | Refractive index of | | D₅₀ | | color quality |
| | index of resin | light diffusing particles | Δn | (μm) | Δn × D₅₀ | of image |
| Ref. Ex. 1 | 1.59 | 1.43 | 0.16 | 0.6 | 0.10 | A |
| Ref. Ex. 2 | 1.59 | 1.49 | 0.10 | 2.3 | 0.23 | A |
| Ref. Ex. 3 | 1.59 | 1.43 | 0.16 | 1.7 | 0.27 | A |
| Ref. Ex. 4 | 1.59 | 1.49 | 0.10 | 4.2 | 0.42 | A |
| Ref. Ex. 5 | 1.59 | 1.49 | 0.10 | 6.0 | 0.60 | A |
| Ref. Ex. 6 | 1.59 | 1.43 | 0.16 | 3.9 | 0.62 | A |
| Ref. Ex. 7 | 1.59 | 1.43 | 0.16 | 6.4 | 1.02 | A |

As can be seen from the results in Table 1, the liquid crystal displays of Examples 1 to 4 according to the present invention could display natural and high-quality color images without red tinge.

In contrast, the liquid crystal displays of Comparative Examples 1 to 3, which are outside the scope of the present invention, displayed color images with red tinge.

As is apparent from the evaluation results shown in Table 2, when a conventional fluorescent light tubes are used as a light source, an image with red tinge was not observed even if the value of “Δn×D₅₀” may be any numerical value, namely, the conventional fluorescent light tube does not suffer from any problem that an image with red tinge is displayed regardless of the value of “Δn×D₅₀” in the fluorescent tube. As described above, the problem such as the replaying of an image with red tinge described in the section, Description of the Related Art, is a problem which specifically arises when an LED is employed as a light source.

The surface light source of the present invention is preferably used as a backlight for a liquid crystal display, but is not limited to this application. The liquid crystal display of the present invention can be preferably used as a liquid crystal TV display, but is not limited to this application.

What is claimed is:

1. A white surface light source comprising a light diffuser plate and a light source provided on the back side of the light diffuser plate,
wherein the light source comprises at least one LED element which emits lights including a red color, and the light diffuser plate comprises a transparent material and light diffusing particles dispersed in the transparent material, and
wherein an absolute value Δn of a refractive index difference between the transparent material and the light diffusing particles, and a 50% cumulative particle diameter D₅₀ (μm) of the light diffusing particles satisfy the relationship:
0.25<Δn×D₅₀<0.61 or
0.75<Δn×D₅₀.

2. The white surface light source according to claim 1, wherein the absolute value Δn of a refractive index difference and the 5096 cumulative particle diameter D₅₀ (μm) of the light diffusing particles satisfy the relationship:
0.75<Δn×D₅₀<1.10.

3. The white surface light source according to claim 1, wherein the absolute value Δn of a refractive index difference is from 0.01 to 0.20.

4. The white surface light source according to claim 1, wherein the 50% cumulative particle diameter D₅₀ (μm) of the light diffusing particles is 20 μm or less.

5. A liquid crystal display comprising a white surface light source according to claim 1, and a liquid crystal panel provided on a front side of the white surface light source.
